(19) United States
(12) Patent Application Publication
(10) Pub. No.: US 2025/0350408 A1
(43) Pub. Date: Nov. 13, 2025

(54) COORDINATION BETWEEN MAC LAYER HARQ AND RLC TRANSMISSIONS

(71) Applicant: QUALCOMM Incorporated, San Diego, CA (US)

(72) Inventor: Linhai HE, San Diego, CA (US)

(21) Appl. No.: 19/201,878

(22) Filed: May 7, 2025

Related U.S. Application Data
(60) Provisional application No. 63/645,088, filed on May 9, 2024.

(51) Int. Cl. H04L 1/1822; H04W 28/06; H04W 72/1273; H04W 72/232

(52) U.S. Cl. CPC H04L 1/1822; H04W 28/06; H04W 72/1273; H04W 72/232

(57) ABSTRACT

Method and apparatus for coordination between HARQ and RLC transmissions. A UE receives, from a network entity, an indication that a HARQ process has failed or terminated for a MAC layer. The UE initiates, at a RLC layer, a retransmission of RLC PDUs in response to receipt of the indication that the HARQ process has failed or terminated for the MAC layer.

### CROSS REFERENCE TO RELATED APPLICATION(S)

This application claims the benefit of and priority to U.S. Provisional Application Ser. No. 63/645,088, entitled “Coordination Between HARQ and RLC Transmissions” and filed on May 9, 2024, which is expressly incorporated by reference herein in its entirety.

### TECHNICAL FIELD

The present disclosure relates generally to communication systems, and more particularly, wireless communication that includes radio link control (RLC) transmissions.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a device at a user equipment (UE). The device may be a processor and/or a modem at a UE or the UE itself. The apparatus receives, from a network entity, an indication that a hybrid automatic repeat request (HARQ) process has failed or terminated for a medium access control (MAC) layer. The apparatus initiates, at a radio link control (RLC) layer, a retransmission of RLC protocol data units (PDUs) in response to receipt of the indication that the HARQ process has failed or terminated for the MAC layer.

In an aspect of the disclosure, a method, a computer-readable medium, and an apparatus are provided. The apparatus may be a device at a network node. The device may be a processor and/or a modem at a network node or the network node itself. The apparatus receives, from a user equipment (UE), one or more transmissions that include radio link control (RLC) protocol data units (PDUs). The apparatus transmits, to the UE, an indication that a hybrid automatic repeat request (HARQ) process for the one or more transmissions has failed or terminated for a medium access control (MAC) layer. The apparatus receives a retransmission of at least one of the RLC PDUs initiated from an RLC layer in response to the indication that the HARQ has failed or terminated for the MAC layer.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network, in accordance with various aspects of the present disclosure.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network, in accordance with various aspects of the present disclosure.

FIG. 4 is a call flow diagram of an example of HARQ and RLC processes, in accordance with various aspects of the present disclosure.

FIG. 5 is a diagram illustrating an example of a user plane protocol stack, in accordance with various aspects of the present disclosure.

FIG. 6 is a call flow diagram of an example of a HARQ failure indication, in accordance with various aspects of the present disclosure.

FIG. 7 is a call flow diagram of signaling between a UE and a base station, in accordance with various aspects of the present disclosure.

FIG. 8A and FIG. 8B are flowcharts of methods of wireless communication, in accordance with various aspects of the present disclosure.

FIG. 9 is a diagram illustrating an example of a hardware implementation for an example apparatus and/or UE, in accordance with various aspects of the present disclosure.

FIG. 10A and FIG. 10B are flowcharts of methods of wireless communication, in accordance with various aspects of the present disclosure.

FIG. 11 is a diagram illustrating an example of a hardware implementation for an example network entity, in accordance with various aspects of the present disclosure.

### DETAILED DESCRIPTION

In wireless communications, HARQ retransmissions and RLC retransmissions may operate separately without coordination between the two processes, e.g., between different layers. For example, if HARQ transmission or retransmissions fails for the MAC layer, the RLC may be unaware of such failure. After a number of retransmissions, the UE may determine that the HARQ process has completed (e.g., failed) and may stop retransmissions, e.g., of a MAC PDU even if the PDU was not successfully delivered. If the network entity does not receive an expected PDU, the UE may perform a retransmission of the RLC PDUs included in the MAC PDU upon expiration of a timer. If the RLC layer at the network entity does not receive a PDU from a lower layer when the timer expires, the network entity may provide a negative acknowledgement (NACK) in a status report to the UE, which may take at least one round trip time (RTT) across the wireless link for the UE to receive the status report from the network entity. Such a delay may be approximately 30 ms, which can be too long of a delay for low latency traffic (e.g., extended reality (XR) applications, among other examples). The time duration of at least one RTT across the wireless link for the UE to be made aware of whether the PDU was successfully delivered may be insufficient to allow the UE to initiate the retransmission. As such, aspects presented herein provide for coordination between the HARQ and RLC procedures to reduce latency and enable more accurate communication to be provided in a more time efficient manner.

Aspects presented herein provide a configuration for coordination between HARQ processes at a MAC layer and RLC retransmissions. For example, a network entity may provide an indication of negative HARQ feedback for a MAC layer (e.g., that a HARQ process has failed or terminated for the MAC layer). The UE may then initiate retransmission of RLC PDUs in response to reception of the indication that the HARQ process has failed or terminated for the MAC layer. The coordination between the MAC layer HARQ process and the RLC retransmission reduced the time for the communication to be retransmitted to the network entity. Such a reduction may help to meet latency requirements for traffic with low latency requirements and may help to improve a user experience.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

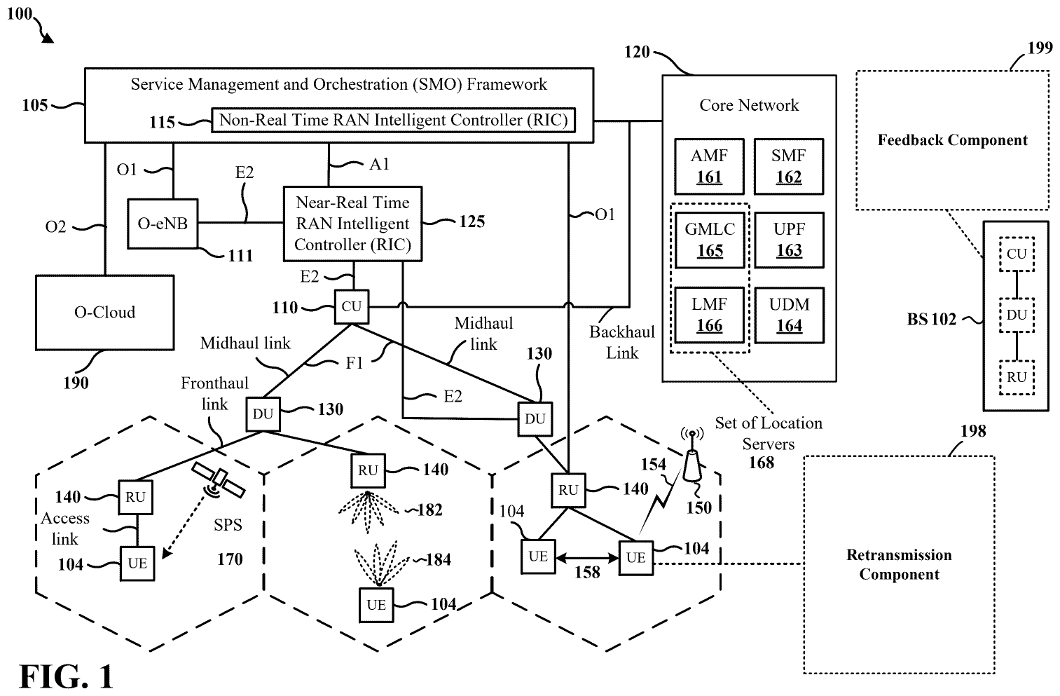

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a retransmission component 198 that may be configured to receive, from a network entity, an indication of negative HARQ feedback; and initiate, at a RLC layer, a retransmission of RLC PDUs in response to receipt of the indication of the negative HARQ feedback.

Referring again to FIG. 1, in certain aspects, the base station 102 may include a feedback component 199 that may be configured to obtain, from a UE, one or more transmissions comprising RLC PDUs; provide, to the UE, an indication of negative HARQ feedback for the one or more transmissions; and obtain a retransmission of at least one of the RLC PDUs initiated from an RLC layer in response to the indication of the negative HARQ feedback.

Although the following description may be focused on 5G NR, the concepts described herein may be applicable to other similar areas, such as LTE, LTE-A, CDMA, GSM, and other wireless technologies.

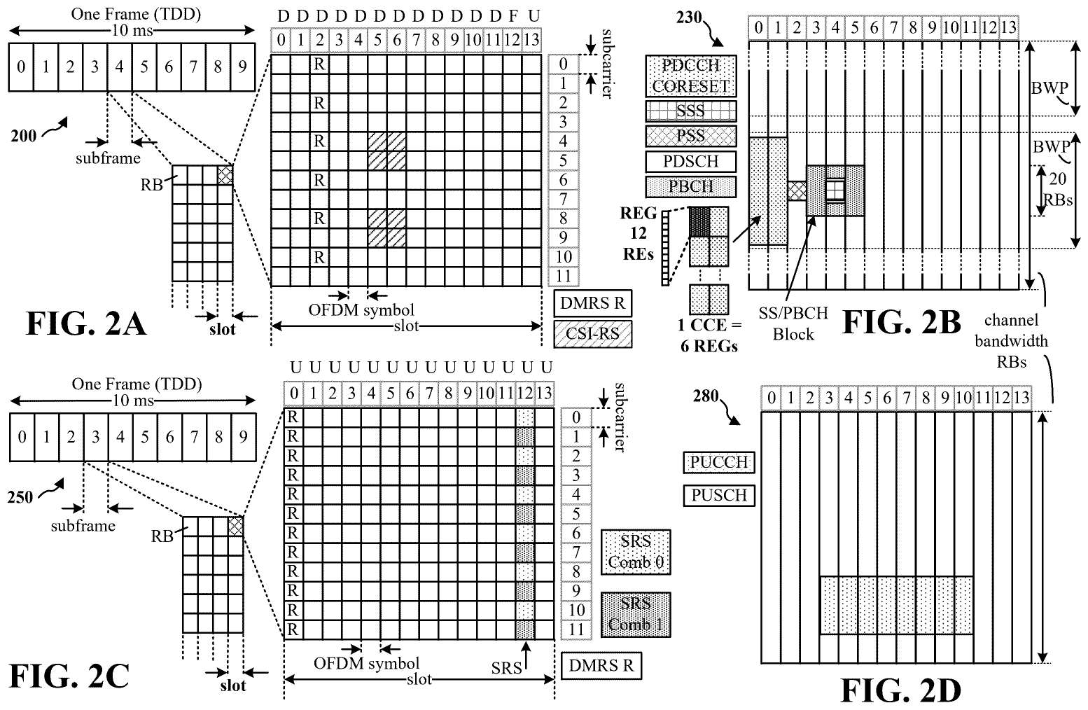

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control in information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where u is the numerology 0 to 4. As such, the numerology μ=0 has a subcarrier spacing of 15 kHz and the numerology u=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

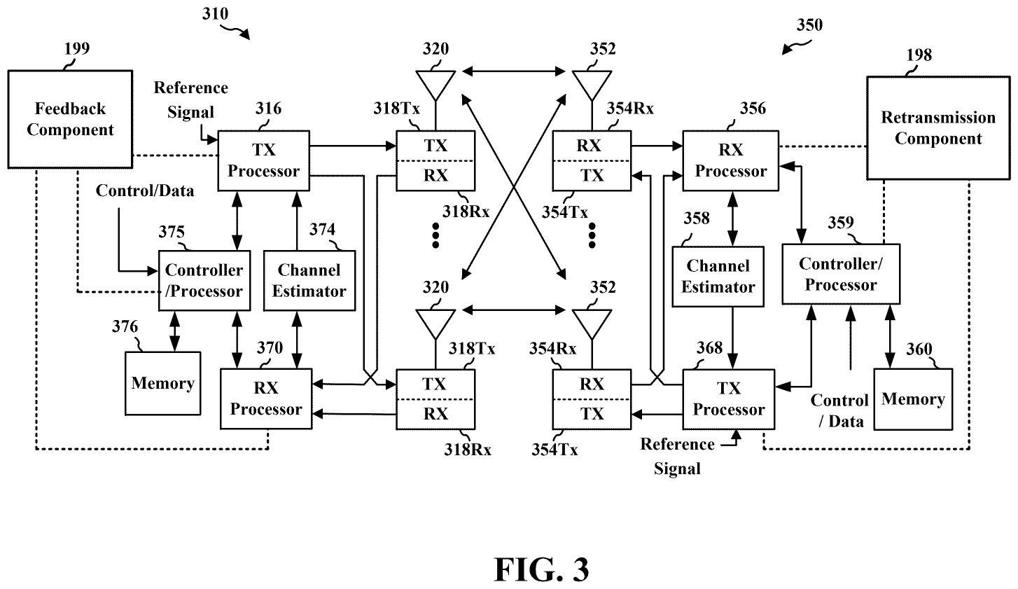

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the retransmission component 198 of FIG. 1.

At least one of the TX processor 316, the RX processor 370, and the controller/processor 375 may be configured to perform aspects in connection with the feedback component 199 of FIG. 1.

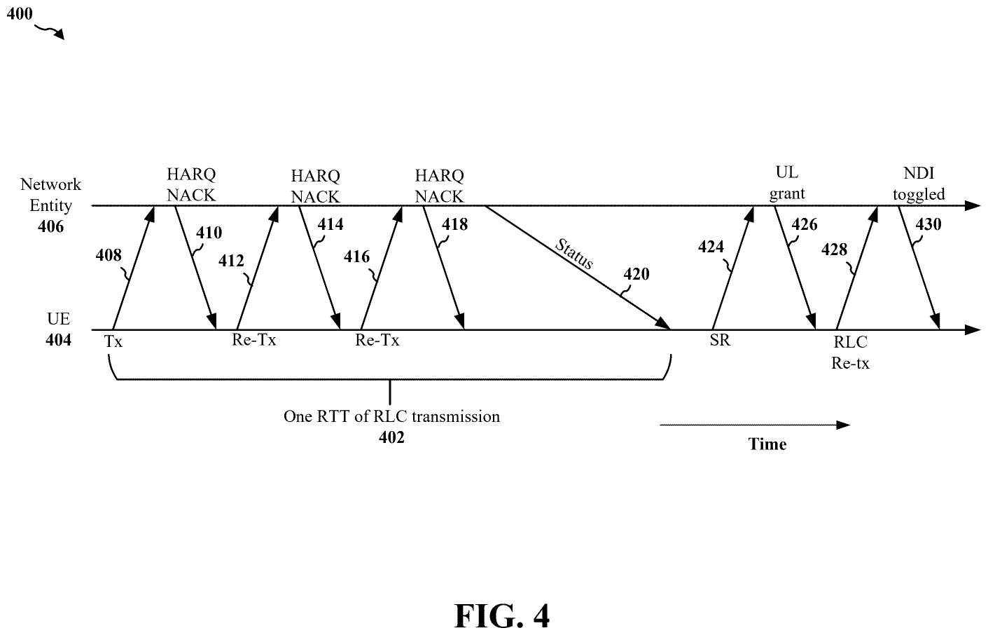

In wireless communications, HARQ retransmissions and RLC retransmissions may operate separately without coordination between the two processes, e.g., between different layers. For example, if HARQ transmission or retransmissions fails for the MAC layer, the RLC may be unaware of such failure. After a number of retransmissions of a MAC PDU (that includes RLC PDU(s)), the UE may determine that the HARQ process has completed (e.g., failed) and may stop retransmissions, e.g., of a MAC PDU even if the PDU was not successfully delivered. The RLC layer may separately use a timer to trigger automatic repeat request (ARQ) retransmission of RLC PDUs. For example, if the network entity does not receive an expected PDU, the UE may perform a retransmission of the RLC PDU(s) upon expiration of the timer. If the RLC layer at the network entity does not receive a PDU from a lower layer when the timer expires, the network entity may provide a negative acknowledgement (NACK) in a status report to the UE, as shown for example in diagram 400 of FIG. 4. The diagram 400 of FIG. 4 illustrates that it may take at least one round trip time (RTT) 402 across the wireless link for the UE to receive feedback (e.g., status report) from the network entity. For example, FIG. 4 illustrates that a UE 404 may transmit a first transmission 408 of one or more MAC PDUs that include one or more RLC PDUs) to a network entity 406 (e.g., which may be a base station in aggregation or one or more components of a base station). The UE 404 receives a HARQ NACK 410 from the network entity 406, and transmits a second transmission 412 (e.g., a retransmission) of the one or more MAC PDUs. The UE 404 receives a HARQ NACK 414 from the network entity 406, and transmits a third transmission 416 (e.g., a retransmission) of the one or more MAC PDUs. In some aspects, a UE may transmit a number of retransmissions. FIG. 4 shows the network entity 406 sending a HARQ NACK 418 for the third transmission 416. The failure of the network entity to successful decode the MAC PDU(s) after the number of retransmissions may be considered a failure of the HARQ process, for example. As the network entity 406 is not able to successfully decode the transmissions of the one or more MAC PDUs (e.g., at 408, 412, and 416), the RLC layer at the network entity does not receive the RLC PDU(s) within the MAC PDU(s). After waiting for a timer to expire, the RLC layer at the network entity 406 transmits a status report 420 to the UE 404 indicating a NACK for the RLC PDU(s). In response to receiving the status report 420, the UE 404 retransmits the RLC PDU(s), e.g., in one or more new MAC PDUs. FIG. 4 illustrates that the UE may send a scheduling request 424 to the network entity 406 requesting resources for the retransmission of the RLC PDU(s). The UE 404 receives an uplink grant 426 (e.g., a scheduling DCI that allocates uplink resources to the UE for the retransmission) from the network entity. The UE 404 retransmits the RLC PDU(s), e.g., in one or more new MAC PDUs, at 428. For example, the transmissions 408, 412, and 416 may be based on a first MAC PDU, and the RLC retransmission at 428 may be based on a second MAC PDU. The UE may then monitor for an indication from the network entity that the retransmission is successfully received. For example, a toggled NDI (e.g., in a scheduling DCI 430) may indicate to the UE 404 that the network entity 406 successfully received the RLC PDU(s) from the second MAC PDU transmission, e.g., 428.

A delay of one RTT (e.g., 402) may be approximately 30 ms, which can be too long of a delay for low latency traffic (e.g., extended reality (XR) applications among other examples of traffic that may have a low latency requirement) that may have a delay budget of at most 50 ms, for example. The time duration of at least one RTT across the wireless link for the UE to be made aware of whether the PDU was successfully delivered may be insufficient to allow the UE to initiate the retransmission. This may be inefficient, especially in instances where the traffic has a low delay budget or is delay sensitive traffic. For example, for XR applications, the delay budget for traffic flow may be within the range of 30-50 ms, but on a wireless link, a typical RTT may be 30 ms. As such, the delay budget for XR traffic may allow for two RLC transmissions across the wireless link, which may be insufficient to achieve a reliability requirement for the XR application. Aspects presented herein provide for a coordination between the HARQ and RLC procedures to reduce latency and enable more accurate communication to be provided in a more time efficient manner.

For example, aspects presented herein provide a configuration for coordination between HARQ processes at a MAC layer and RLC transmissions to provide an RLC retransmission with a reduced delay by triggering a transmission (e.g., retransmission) at the RLC layer based on negative HARQ feedback received in a MAC message (e.g., a MAC layer indication that the HARQ process as failed or terminated for the MAC layer). By triggering the RLC retransmission based on the reception of the HARQ feedback at the MAC layer, rather than waiting for the status report helps to shorten the time before a UE transmits an RLC retransmission. For example, a network entity may provide an indication that a HARQ process has failed or terminated (e.g., negative HARQ feedback) for a MAC layer, which may allow a UE to initiate retransmission of RLC PDUs in response to reception of the indication. At least one advantage of the disclosure is that retransmission of RLC PDUs may occur without waiting for a status report from the network entity, which reduces latency and helps to ensure that the network entity successfully receives the communication in a more time efficient manner.

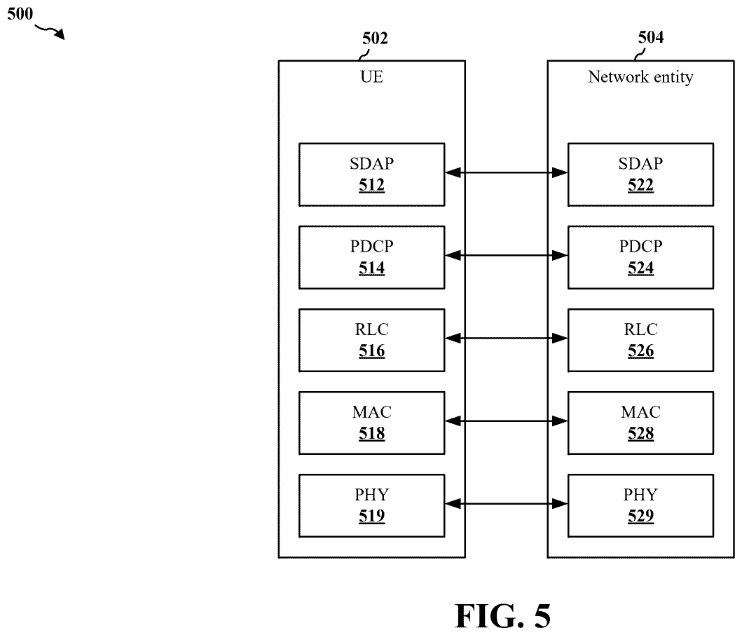

In some aspects, radio protocol stack may have different stacks based on the type of data that is processed by the stack. For example, user data may go through a user plane protocol stack, while data that is signaling message goes through control plane protocol stack. The user plane protocol stack may have a structure of a PHY layer (e.g., 519 at the UE 502 and 529 at the network entity 504), MAC layer (e.g., 518 at the UE 502 and 528 at the network entity 504), RLC layer (e.g., 516 at the UE 502 and 526 at the network entity 504), PDCP layer (e.g., 514 at the UE 502 and 524 at the network entity 504), and SDAP layer (e.g., 512 at the UE 502 and 522 at the network entity 504), as shown for example in diagram 500 of FIG. 5.

As presented herein, in some aspects, when a MAC layer 518 at the UE 502 detects a HARQ process failure or termination, the MAC layer 518 may inform the RLC layer 516, which may then trigger a RLC retransmission without waiting for a status report (e.g., 420) from the network entity 504.

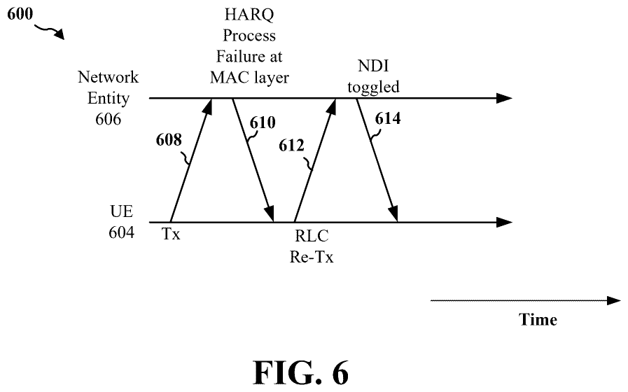

The network entity may be configured to send an indication to UE, informing the UE that a HARQ process has failed or terminated. The indication enables the UE to determine that the MAC layer may stop transmitting the PDU and it is now the responsibility of the RLC layer to ensure reliable delivery through RLC retransmission. The indication from the network entity may be sent by either a DCI (e.g., L1 signaling) or a medium access control (MAC) control element (CE) (MAC-CE) (e.g., L2 signaling), for example. In some aspects, the indication may include an identifier (ID) of the HARQ process that has been stopped (e.g., has failed or terminated). Upon reception of this indication at the MAC layer 518 of the UE 502, the UE 502 may inform the RLC layer 516 to initiate retransmission of the RLC PDUs that were included in the MAC PDU for which the HARQ process has failed or terminated. If the UE receives a scheduling DCI with an NDI bit toggled, before it receives an indication for HARQ failure, reception of the DCI with the toggled bit may be understood by the UE to mean that the corresponding HARQ process has succeeded, as shown for example in FIG. 6. Upon this event, the UE may inform the RLC layer 516 to discard the RLC PDUs which were included in the MAC PDU that was sent by that HARQ process, such that the RLC PDUs have been successfully received and the UE can stop buffering the RLC PDUs. FIG. 6 illustrates an example communication flow 600 between a UE 604 and a network entity 606 (e.g., which may correspond to a base station in aggregation or one or more components of a disaggregated base station). The UE 604 sends a transmission 608 of a first MAC PDU that includes one or more RLC PDUs, e.g., as described in connection with 406 in FIG. 4. Although not illustrated, the UE 604 may transmit one or more retransmissions of the MAC PDU, e.g., as described in connection with 512 and 516 in FIG. 5. In response to detecting a HARQ process failure or termination for a MAC layer, the network entity 606 sends (e.g., transmits) an indication 610 of the HARQ process failure or termination for the MAC layer to the UE 604. The indication 610 may be sent in L1 signaling (e.g., DCI) or L2 signaling (e.g., MAC-CE), for example. The indication 610 may indicate a HARQ process ID for the HARQ process that failed or was terminated. In response to receiving the indication of the HARQ process failure/termination, at 610, the UE 604 initiates and transmits a retransmission of the RLC PDUs, at 612. For example, the UE 604 retransmits the RLC PDUs that were included in the first MAC PDU (e.g., 608) through transmission in a second MAC PDU at 612. The UE 604 may initiate the retransmission of the RLC PDUs by informing the RLC layer that the HARQ processes for the MAC layer have failed or been terminated. In contrast to the example in FIG. 4, the UE 604 retransmits the RLC retransmission without waiting for a timer expiration that triggers a status report 420. Instead, the UE 604 is able to initiate the RLC retransmission with reduced latency by receiving the indication 610 that the HARQ process has failed or terminated for the MAC layer and providing the information from the MAC layer (e.g., 518) to the RLC layer (e.g., 516) of the UE so that the RLC layer can more quickly initiate an RLC retransmission.

After transmitting the RLC retransmission, the UE 604 may then monitor for a further indication from the network entity 606 about whether the retransmission was successfully received at the network entity. As an example, the UE may monitor for a toggled NDI in a scheduling DCI, which the UE 604 can interpret to mean that the HARQ process for the retransmission succeeded. After receiving the toggled NDI (e.g., in the scheduling DCI 614), the RLC layer at the UE may discard the RLC PDUs that were retransmitted. The scheduling DCI with the toggled NDI bit may be received, e.g., before an indication regarding HARQ failure, for example. Although not illustrated, if the HARQ process fails for the RLC retransmission, the network entity 606 may send another indication of the HARQ process failure, and the UE may trigger another RLC retransmission.

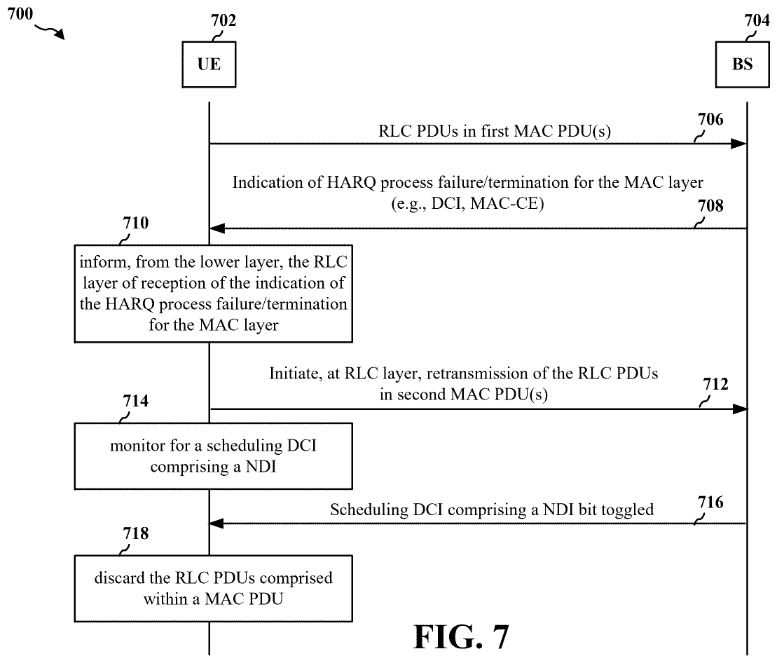

FIG. 7 is a call flow diagram 700 of signaling between a UE 702 and a base station 704. The aspects performed by the base station 704 may be performed by a base station in aggregation or by one or more components of a disaggregated base station (e.g., a CU, DU, and/or RU). The base station 704, or one or more components of the base station, may also be referred to as a network entity or network node. The UE 702 may correspond to the UE 104, 350, 404, 502, and/or 604, for example. The base station 704 may correspond to the base station 102, 310, and/or the network entity 406, 504, or 606, for example. The base station 704 may be configured to provide at least one cell. The UE 702 may be configured to communicate with the base station 704 through exchanging wireless transmissions. For example, in the context of FIG. 1, the base station 704 may correspond to base station 102 and the UE 702 may correspond to at least UE 104. In another example, in the context of FIG. 3, the base station 704 may correspond to base station 310 and the UE 702 may correspond to UE 350. In the context of FIG. 5, the UE 702 may correspond to 502, and the base station 704 may correspond to the network entity 504. In the context of FIG. 6, the UE 702 may correspond to 604, and the base station 704 may correspond to the network entity 606.

At 706, the UE 702 may transmit one or more transmissions including RLC PDUs. For example, the RLC PDU(s) may be transmitted in one or more MAC PDUs, e.g., as described in connection with FIG. 4 and/or FIG. 6, for example. The UE may transmit the one or more transmissions including the RLC PDUs to the base station 704. As an example, FIG. 4 illustrates a first transmission and two retransmissions of a MAC PDU that includes RLC PDU(s). The base station 704 may receive the one or more transmissions including the RLC PDUs from the UE 702, but not successfully decode the received PDUs.

At 708, the base station 704 sends (e.g., transmits) an indication of a HARQ process failure or termination for the one or more transmissions at the MAC layer. The indication may include any of the aspects described in connection with the indication 610, for example. The base station 704 may send the indication of the HARQ process failure/termination for the one or more transmissions to the UE 702 in a MAC-CE or DCI, for example. The UE 702 may receive the indication of the HARQ process failure/termination from the base station. In some aspects, the indication of the negative HARQ feedback may include an ID of the HARQ process that has failed or terminated. As an example, the UE 702 may include an original set (or a first set) of RLC PDUs within a first set of one or more MAC PDUs at 708, and the for which the indication of the HARQ process failure may be for the first set of one or more MAC PDUs. In some aspects, a MAC layer of the base station 704 may provide the indication of the HARQ process failure for the MAC layer to the UE 702.

At 710, the UE 702 may inform, from the lower layer (e.g., MAC layer) to the RLC layer of the UE, of the reception of the indication of the failed/terminated HARQ process. The RLC layer of the UE may receive the indication of the negative HARQ feedback from the MAC layer, such that the RLC layer of the UE 702 is informed of the reception of the indication of the failed/terminated HARQ process (e.g., which may be referred to as HARQ feedback for a HARQ process failure at the MAC layer).

At 712, the UE 702 (e.g., RLC layer of the UE) may initiate and transmit a retransmission of RLC PDUs, e.g., in a second set of one or more MAC PDUs. The base station 704 may receive the retransmission of the RLC PDUs from the UE 702. The UE 702 may initiate the retransmission of the RLC PDUs in response to receipt of the indication of the HARQ process failure or termination (e.g., which may be referred to as negative HARQ for the MAC layer HARQ process, in some aspects).

At 714, the UE 702 may monitor for an indication as to whether the retransmission of the RLC PDUs is successful. In some aspects, the UE 702 may monitor for a scheduling DCI from the base station that includes a new data indicator (NDI). The scheduling DCI including the NDI may be utilized to determine whether the retransmitted RLC PDUs were properly obtained by the base station. For example, a value of the NDI may indicate whether the base station received the RLC PDUs, e.g., a toggled NDI may indicate new data informing the UE that the base station 704 successfully received the RLC PDUs and a non-toggled NDI or reuse of a prior NDI value may indicate that the base station has not yet successfully received the RLC PDUs.

At 716, the base station 704 may provide a scheduling DCI to the UE 702. The UE 702 may receive the scheduling DCI from the base station. The scheduling DCI may include a toggled NDI bit that indicates that a HARQ process for the RLC PDUs were retransmitted successfully. The toggling of the NDI bit within the scheduling DCI may be utilized by the UE to determine that the HARQ process for the RLC PDUs was successful at the network entity.

At 718, the UE may discard the RLC PDUs comprised within a MAC PDU based on reception of the DCI comprising the NDI bit toggled. Receipt of a scheduling DCI including a NDI bit toggled indicates that an initial transmission or a retransmission of the RLC PDUs was successfully received by the base station. As such, the UE, for example, may discard the RLC PDUs from a UE buffer or memory.

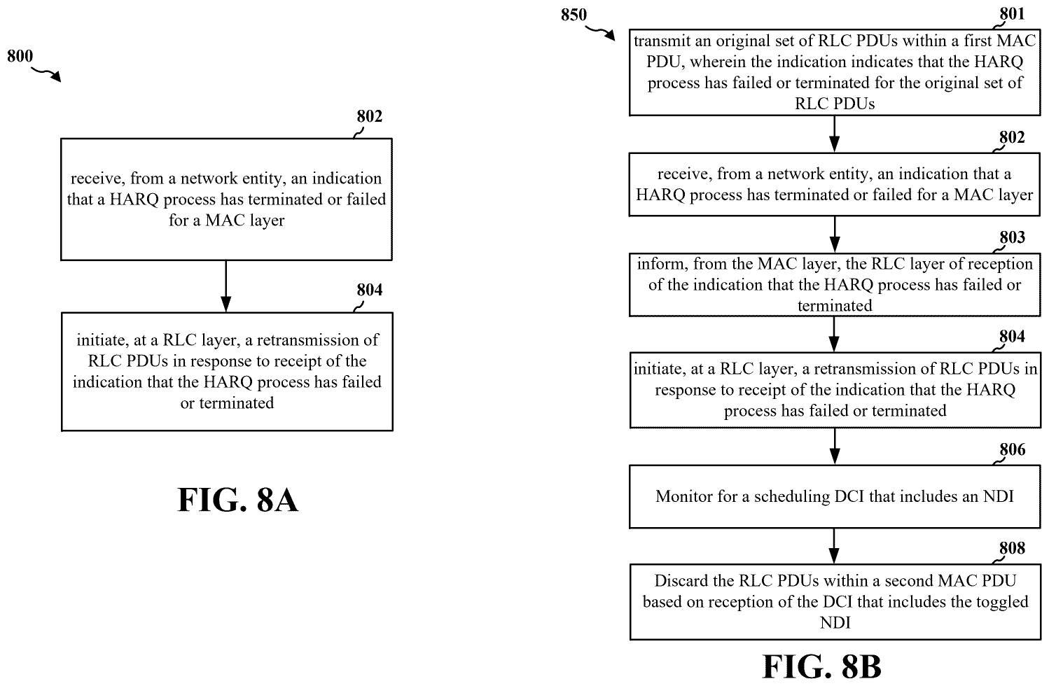

FIG. 8A is a flowchart 800 of a method of wireless communication. The method may be performed by a UE (e.g., the UE 104, 350, 404, 502, 604, 702; the apparatus 904). One or more of the illustrated operations may be omitted, transposed, or contemporaneous. The method enables coordination between a MAC layer HARQ process and RLC retransmission to reduce the time for the communication to be retransmitted to the network entity. Such a reduction may help to meet latency requirements for traffic with low latency requirements and/or may help to improve a user experience.

At 802, the UE may receive an indication of that a HARQ process has failed or terminated. FIG. 6 illustrates an example of a UE receiving an indication 610, and FIG. 7 illustrates an example of a UE receiving an indication at 708. For example, 802 may be performed by retransmission component 198 of apparatus 904. The UE may receive the indication of the HARQ process failure or termination from a network entity. In some aspects, the indication of the HARQ process failure or termination may be received in at least one of DCI or MAC-CE. In some aspects, the indication of the HARQ process failure may include an identifier (ID) of the HARQ process that has failed or terminated.

At 804, the UE may initiate a retransmission of RLC PDUs. The RLC layer may initiate the retransmission of the RLC PDUs based on information from the MAC layer that the HARQ process is failed or terminated, for example. FIGS. 6 and 7 illustrate examples of retransmissions at 612 and 712. For example, 804 may be performed by retransmission component 198 of apparatus 904.

The method may further include any of the aspects described in connection with the UE in FIGS. 4-7, for example.

FIG. 8B is a flowchart 850 of a method of wireless communication. The method may be performed by a UE (e.g., the UE 104, 350, 404, 502, 604, 702; the apparatus 904). One or more of the illustrated operations may be omitted, transposed, or contemporaneous. The method enables coordination between a MAC layer HARQ process and RLC retransmission to reduce the time for the communication to be retransmitted to the network entity. Such a reduction may help to meet latency requirements for traffic with low latency requirements and/or may help to improve a user experience.

As illustrated at 801, in some aspects, the UE may the UE may transmit an original set of RLC PDUs within a first MAC PDU. FIGS. 6 and 7 illustrate examples of a first transmission of RLC PDU(s) in first MAC PDU(s) at 608 and 706. The transmission may be performed, e.g., by one or more of the retransmission component 198, the transceiver 922 and/or antenna 980 of the apparatus 904.

At 802, the UE may receive an indication of that a HARQ process has failed or terminated. FIG. 6 illustrates an example of a UE receiving an indication 610, and FIG. 7 illustrates an example of a UE receiving an indication at 708. For example, 802 may be performed, e.g., by one or more of the retransmission component 198, the transceiver 922 and/or antenna 980 of the apparatus 904. The UE may receive the indication of the HARQ process failure or termination from a network entity. In some aspects, the indication of the HARQ process failure or termination may be received in at least one of DCI or MAC-CE. In some aspects, the indication of the HARQ process failure may include an identifier (ID) of the HARQ process that has failed or terminated. In some aspects, the UE may transmit an original set of RLC PDUs within a first MAC PDU, at 801, and the indication may indicate that the HARQ process failed or terminated at the MAC layer for the original set of RLC PDUs (e.g., for the MAC PDU carrying the original RLC PDUs).

In some aspects, a lower layer (e.g., MAC layer) of the UE may receive the indication that the HARQ process failed or terminated for the MAC layer. In such instances, at 803, the UE may inform, from the MAC layer, the RLC layer of reception of the indication that the HARQ process failed or terminated for the MAC layer. FIG. 7 illustrates an example of a UE informing, at 710, the RLC layer that an indication of a HARQ process failure/termination for the MAC layer has been received.

At 804, the UE may initiate a retransmission of RLC PDUs. The RLC layer may initiate the retransmission of the RLC PDUs based on information from the MAC layer that the HARQ process is failed or terminated, for example. FIGS. 6 and 7 illustrate examples of retransmissions at 612 and 712. For example, 804 may be performed, e.g., by one or more of the retransmission component 198, the transceiver 922 and/or antenna 980 of the apparatus 904.

In some aspects, the UE may monitor, at 806 for a scheduling DCI from the network entity that includes an NDI. At 806, the UE may receive the scheduling DCI with the toggled NDI. In some aspects, receipt of the scheduling DCI including the NDI bit toggled may indicate that transmission (e.g., the initial transmission or the retransmission) of the RLC PDUs was successfully received by the network entity. The monitoring and/or reception may be performed, e.g., by one or more of the retransmission component 198, the transceiver 922 and/or antenna 980 of the apparatus 904.

In such instances, at 808, the UE may discard the RLC PDUs comprised within a MAC PDU based on reception of the DCI including the NDI bit toggled. For example, the UE may discard the RLC PDUs from a UE buffer or memory. The discard may be performed, e.g., by the retransmission component 198 of the apparatus 904.

The method may further include any of the aspects described in connection with the UE in FIGS. 4-7, for example.

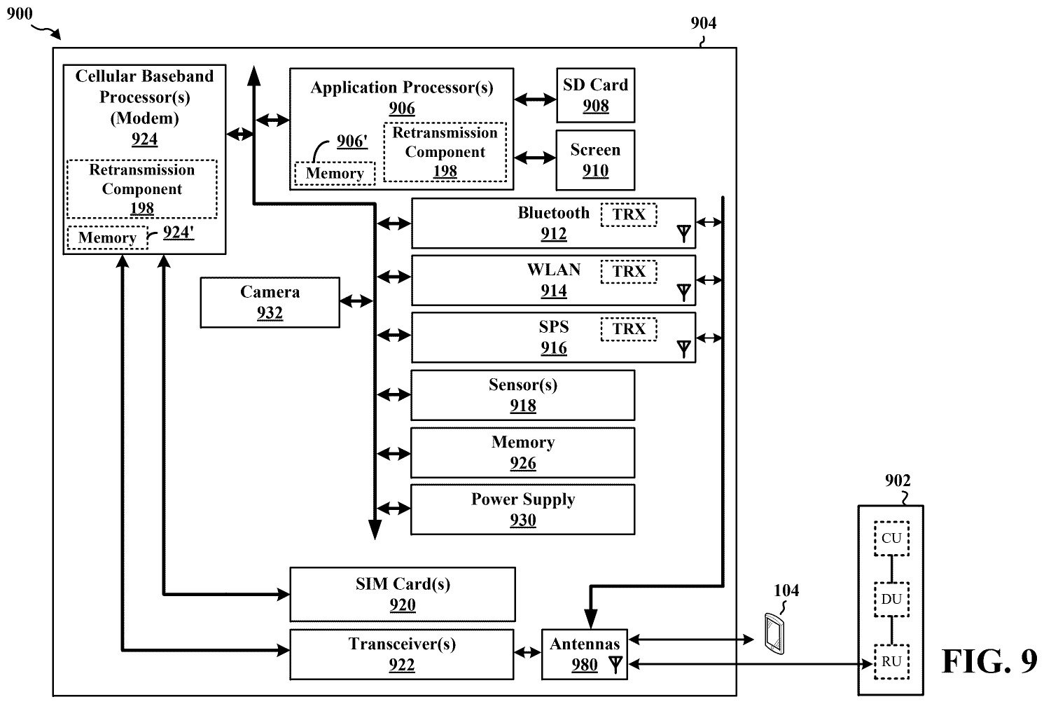

FIG. 9 is a diagram 900 illustrating an example of a hardware implementation for an apparatus 904. The apparatus 904 may be a UE, a component of a UE, or may implement UE functionality. In some aspects, the apparatus 904 may include at least one cellular baseband processor 924 (also referred to as a modem) coupled to one or more transceivers 922 (e.g., cellular RF transceiver). The cellular baseband processor(s) 924 may include at least one on-chip memory 924′. In some aspects, the apparatus 904 may further include one or more subscriber identity modules (SIM) cards 920 and at least one application processor 906 coupled to a secure digital (SD) card 908 and a screen 910. The application processor(s) 906 may include on-chip memory 906′. In some aspects, the apparatus 904 may further include a Bluetooth module 912, a WLAN module 914, an SPS module 916 (e.g., GNSS module), one or more sensor modules 918 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 926, a power supply 930, and/or a camera 932. The Bluetooth module 912, the WLAN module 914, and the SPS module 916 may include an on-chip transceiver (TRX) (or in some cases, just a receiver (RX)). The Bluetooth module 912, the WLAN module 914, and the SPS module 916 may include their own dedicated antennas and/or utilize the antennas 980 for communication. The cellular baseband processor(s) 924 communicates through the transceiver(s) 922 via one or more antennas 980 with the UE 104 and/or with an RU associated with a network entity 902. The cellular baseband processor(s) 924 and the application processor(s) 906 may each include a computer-readable medium/memory 924′, 906′, respectively. The additional memory modules 926 may also be considered a computer-readable medium/memory. Each computer-readable medium/memory 924′, 906′, 926 may be non-transitory. The cellular baseband processor(s) 924 and the application processor(s) 906 are each responsible for general processing, including the execution of software stored on the computer-readable medium/memory. The software, when executed by the cellular baseband processor(s) 924/application processor(s) 906, causes the cellular baseband processor(s) 924/application processor(s) 906 to perform the various functions described supra. The cellular baseband processor(s) 924 and the application processor(s) 906 are configured to perform the various functions described supra based at least in part of the information stored in the memory. That is, the cellular baseband processor(s) 924 and the application processor(s) 906 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 924/application processor(s) 906 when executing software. The cellular baseband processor(s) 924/application processor(s) 906 may be a component of the UE 350 and may include the at least one memory 360 and/or at least one of the TX processor 368, the RX processor 356, and the controller/processor 359. In one configuration, the apparatus 904 may be at least one processor chip (modem and/or application) and include just the cellular baseband processor(s) 924 and/or the application processor(s) 906, and in another configuration, the apparatus 904 may be the entire UE (e.g., see UE 350 of FIG. 3) and include the additional modules of the apparatus 904.

As discussed supra, the retransmission component 198 may be configured to receive, from a network entity, an indication that a hybrid automatic repeat request (HARQ) process has failed or terminated for a medium access control (MAC) layer; and initiate, at a radio link control (RLC) layer, a retransmission of RLC protocol data units (PDUs) in response to receipt of the indication that the HARQ process has failed or terminated for the MAC layer. The retransmission component 198 or the apparatus 904 may be further configured to inform, from the MAC layer, the RLC layer of reception of the indication that the HARQ process has failed or terminated, wherein the RLC layer initiates the retransmission of the RLC PDUs based on information from the MAC layer that the HARQ process has failed or terminated. The retransmission component 198 or the apparatus 904 may be further configured to transmit an original set of RLC PDUs within a MAC PDU, wherein the indication indicates that the HARQ process has failed or terminated for the original set of RLC PDUs. The retransmission component 198 or the apparatus 904 may be further configured to discard the RLC PDUs included within a MAC PDU based on the reception of the DCI that includes the toggled NDI bit. The retransmission component 198 or the apparatus 904 may be further configured to monitor for a scheduling downlink control information (DCI) that includes a new data indicator (NDI). The retransmission component 198 may be configured to perform any of the aspects described in connection with the flowchart in FIG. 8A, FIG. 8B, and/or performed by the UE in any of FIGS. 4-7. The retransmission component 198 may be within the cellular baseband processor(s) 924, the application processor(s) 906, or both the cellular baseband processor(s) 924 and the application processor(s) 906. The retransmission component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 904 may include a variety of components configured for various functions. In one configuration, the apparatus 904, and in particular the cellular baseband processor(s) 924 and/or the application processor(s) 906, may include means for receiving, from a network entity, an indication that a hybrid automatic repeat request (HARQ) process has failed or terminated at a medium access control (MAC) layer; and means for initiating, at a radio link control (RLC) layer, a retransmission of RLC protocol data units (PDUs) in response to receipt of the indication that the HARQ process has failed for the MAC layer. The apparatus 904 may further include means for informing, from the MAC layer, the RLC layer of reception of the indication that the HARQ process has failed or terminated, wherein the RLC layer initiates the retransmission of the RLC PDUs based on information from the MAC layer that the HARQ process has failed or terminated. The apparatus 904 may further include means for transmitting an original set of RLC PDUs within a first MAC PDU, wherein the indication indicates that the HARQ process has failed or terminated for the original set of RLC PDUs. The apparatus 904 may further include means for monitoring for a scheduling downlink control information (DCI) that includes a new data indicator (NDI), wherein reception of a scheduling downlink control information (DCI) that includes a toggled NDI bit indicates that an initial transmission or the retransmission of the RLC PDUs was successfully received. The apparatus 904 may further include means for discarding the RLC PDUs included within a second MAC PDU based on the reception of the scheduling DCI that includes the NDI bit toggled. The apparatus may include means for performing any of the aspects described in connection with the flowchart in FIG. 8A, FIG. 8B, and/or performed by the UE in any of FIGS. 4-7. The means may be the retransmission component 198 of the apparatus 904 configured to perform the functions recited by the means. As described supra, the apparatus 904 may include the TX processor 368, the RX processor 356, and the controller/processor 359. As such, in one configuration, the means may be the TX processor 368, the RX processor 356, and/or the controller/processor 359 configured to perform the functions recited by the means.

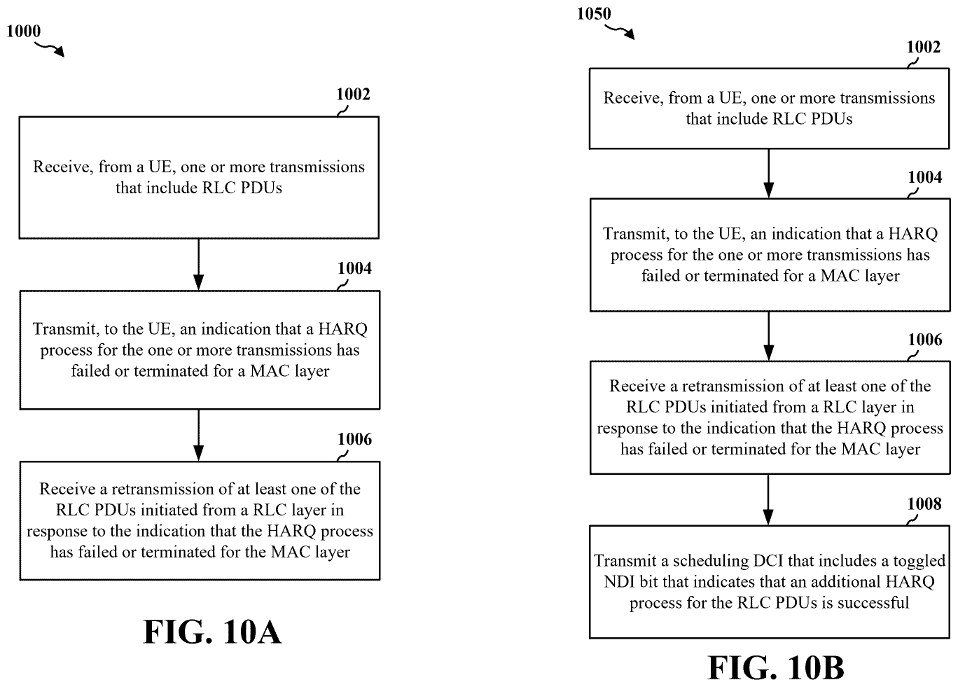

FIGS. 10A and 10B are flowcharts 1000 and 1050 of methods of wireless communication. The methods may be performed by a base station (e.g., the base station 102, 310, 704; the network entity 406, 504, 606, 902, 1102) or one or more components of a base station (e.g. CU 110, DU 130, and/or RU 140). One or more of the illustrated operations may be omitted, transposed, or contemporaneous. The method may allow the network entity to improve reception of communication at the network entity by reducing latency. For example, a coordination between a MAC layer HARQ process and RLC retransmission may help to reduce the time for retransmissions of the communication to be received by the network entity. Such a reduction may help to meet latency requirements for traffic with low latency requirements and/or may help to improve a user experience.

At 1002, the network entity may receive one or more transmissions including RLC PDUs. For example, 1002 may be performed by feedback component 199 of network entity 1102. The network entity may obtain the one or more transmissions comprising the RLC PDUs from a UE.

At 1004, the network entity may transmit an indication that a hybrid automatic repeat request (HARQ) process for the one or more transmissions has failed or terminated for a medium access control (MAC) layer. For example, 1004 may be performed by feedback component 199 of network entity 1102. The network entity may provide the indication for the one or more transmissions to the UE, e.g., as described in connection with any of the examples in FIGS. 6 and/or 7. In some aspects, the indication of the negative HARQ feedback may be provided via at least one of DCI or MAC-CE. In some aspects, the indication of the negative HARQ feedback may include an ID of the HARQ process that has terminated or failed for the MAC layer. In some aspects, an original set of RLC PDUs within the one or more transmissions may have been included within a MAC PDU for which the indication was provided. In some aspects, a MAC layer of the network entity may provide, to the UE, the indication that the HARQ process has failed or terminated for the MAC layer.

At 1006, the network entity may receive a retransmission of at least one of the RLC PDUs initiated from a radio link control (RLC) layer in response to the indication that the HARQ process has failed or terminated for the MAC layer. For example, 1006 may be performed by feedback component 199 of network entity 1102. The network entity may receive the retransmission of at least one of the RLC PDUs from the UE. The network entity may receive the retransmission of at least one of the RLC PDUs initiated from the RLC layer in response to providing the indication to the UE.

As shown at 1008 in the example flowchart 1050 of FIG. 10B, in some aspects, the network entity may transmit a scheduling DCI including a toggled NDI bit that indicates that a HARQ process for the RLC PDUs were retransmitted successfully. The toggling of the NDI bit within the scheduling DCI informs the UE that the HARQ process for the RLC PDUs were successfully obtained by the network entity. Aspects of the flowchart of FIG. 10B that are described in connection with FIG. 10A are shown with a same reference number.

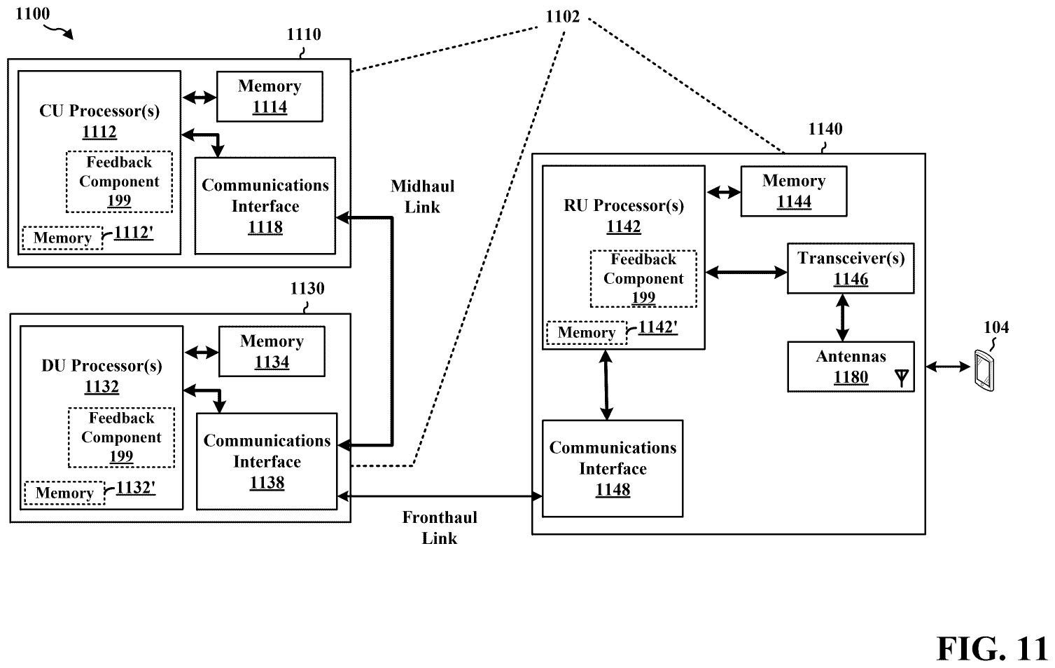

FIG. 11 is a diagram 1100 illustrating an example of a hardware implementation for a network entity 1102. The network entity 1102 may be a BS, a component of a BS, or may implement BS functionality. The network entity 1102 may include at least one of a CU 1110, a DU 1130, or an RU 1140. For example, depending on the layer functionality handled by the component 199, the network entity 1102 may include the CU 1110; both the CU 1110 and the DU 1130; each of the CU 1110, the DU 1130, and the RU 1140; the DU 1130; both the DU 1130 and the RU 1140; or the RU 1140. The CU 1110 may include at least one CU processor 1112. The CU processor(s) 1112 may include on-chip memory 1112′. In some aspects, the CU 1110 may further include additional memory modules 1114 and a communications interface 1118. The CU 1110 communicates with the DU 1130 through a midhaul link, such as an F1 interface. The DU 1130 may include at least one DU processor 1132. The DU processor(s) 1132 may include on-chip memory 1132′. In some aspects, the DU 1130 may further include additional memory modules 1134 and a communications interface 1138. The DU 1130 communicates with the RU 1140 through a fronthaul link. The RU 1140 may include at least one RU processor 1142. The RU processor(s) 1142 may include on-chip memory 1142′. In some aspects, the RU 1140 may further include additional memory modules 1144, one or more transceivers 1146, antennas 1180, and a communications interface 1148. The RU 1140 communicates with the UE 104. The on-chip memory 1112′, 1132′, 1142′ and the additional memory modules 1114, 1134, 1144 may each be considered a computer-readable medium/memory. Each computer-readable medium/memory may be non-transitory. Each of the processors 1112, 1132, 1142 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to receive, from a user equipment (UE), one or more transmissions that include radio link control (RLC) protocol data units (PDUs); transmit, to the UE, an indication that a hybrid automatic repeat request (HARQ) process for the one or more transmissions has failed or terminated for a medium access control (MAC) layer; and receive a retransmission of at least one of the RLC PDUs initiated from a radio link control (RLC) layer in response to the indication that the HARQ process has failed or terminated for the MAC layer. The feedback component 199 and/or network entity 1102 may be further configured to transmit a scheduling downlink control information (DCI) that includes a toggled new data indicator (NDI) bit that indicates that an additional HARQ process for the RLC PDUs is successful. The component 199 may be configured to perform any of the aspects described in connection with the flowchart in FIG. 10A, FIG. 10B, and/or performed by the base station in any of FIGS. 4-7. The component 199 may be within one or more processors of one or more of the CU 1110, DU 1130, and the RU 1140. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1102 may include a variety of components configured for various functions. In one configuration, the network entity 1102 may include means for obtaining, from a UE, one or more transmissions comprising RLC PDUs. The network entity includes means for receiving, from a user equipment (UE), one or more transmissions that include radio link control (RLC) protocol data units (PDUs); means for transmitting, to the UE, an indication that a hybrid automatic repeat request (HARQ) process for the one or more transmissions has failed or terminated for the MAC layer; and means for receiving a retransmission of at least one of the RLC PDUs initiated from a radio link control (RLC) layer in response to the indication that the HARQ process has failed or terminated for the MAC layer. The network entity 1102 may further include means for transmitting a scheduling downlink control information (DCI) that includes a new data indicator (NDI) bit toggled that indicates that an additional HARQ process for the RLC PDUs is successful. The network entity 1102 may include means for performing any of the aspects described in connection with the flowchart in FIG. 10A, FIG. 10B, and/or performed by the base station in any of FIGS. 4-7. The means may be the component 199 of the network entity 1102 configured to perform the functions recited by the means. As described supra, the network entity 1102 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” or “based on or otherwise in association with” unless specifically recited differently. As used herein, the phrase “associated with” encompasses any association, relation, or connection link. Among other examples, the phrase “associated with” may include in association with, based on, based at least in part on, corresponding to, related to, in response to, linked with, and/or connected with. As used herein, “using” may include any use, which may include any consideration, any calculation, and/or any dependency, among examples of use.

The following aspects are illustrative only and may be combined with other aspects or teachings described herein, without limitation.

Aspect 1 is a method of wireless communication at a UE comprising receiving, from a network entity, an indication of negative HARQ feedback; and initiating, at a RLC layer, a retransmission of RLC PDUs in response to receipt of the indication of the negative HARQ feedback.

Aspect 2 is the method of aspect 1, further includes that the indication of the negative HARQ feedback is received via at least one of DCI or MAC-CE.

Aspect 3 is the method of any of aspects 1 and 2, further includes that the indication of the negative HARQ feedback comprises an ID of a HARQ process where transmission has terminated.

Aspect 4 is the method of any of aspects 1-3, further includes that an original set of RLC PDUs were comprised within a MAC PDU for which the negative HARQ feedback is received.

Aspect 5 is the method of any of aspects 1-4, further includes that reception of a scheduling DCI comprising a NDI bit toggled indicates that an initial transmission or the retransmission of the RLC PDUs was successfully received.

Aspect 6 is the method of any of aspects 1-5, further including discard the RLC PDUs comprised within a MAC PDU based on the reception of the DCI comprising the NDI bit toggled.

Aspect 7 is the method of any of aspects 1-6, further including monitoring for a scheduling DCI comprising a NDI.

Aspect 8 is the method of any of aspects 1-7, further includes that a lower layer of the UE receives the indication of the negative HARQ feedback, further including informing, from the lower layer, the RLC layer of reception of the indication of the negative HARQ feedback.

Aspect 9 is an apparatus for wireless communication at a UE including at least one processor coupled to a memory and at least one transceiver, the at least one processor configured to implement any of aspects 1-8.

Aspect 10 is an apparatus for wireless communication at a UE including means for implementing any of aspects 1-8.

Aspect 11 is a computer-readable medium (e.g., non-transitory) storing computer executable code, where the code when executed by a processor causes the processor to implement any of aspects 1-8.

Aspect 12 is a method of wireless communication at a network entity comprising obtaining, from a UE, one or more transmissions comprising RLC PDUs; providing, to the UE, an indication of negative HARQ feedback for the one or more transmissions; and obtaining a retransmission of at least one of the RLC PDUs initiated from a RLC layer in response to the indication of the negative HARQ feedback.

Aspect 13 is the method of aspect 12, further includes that the indication of the negative HARQ feedback is provided via at least one of DCI or MAC-CE.

Aspect 14 is the method of any of aspects 12 and 13, further includes that the indication of the negative HARQ feedback comprises an ID of a HARQ process where transmission has terminated.

Aspect 15 is the method of any of aspects 12-14, further includes that an original set of RLC PDUs within the one or more transmissions were comprised within a medium access control (MAC) PDU for which the negative HARQ feedback was provided.

Aspect 16 is the method of any of aspects 12-15, further including providing a scheduling DCI comprising a NDI bit toggled that indicates that a HARQ process for the RLC PDUs were retransmitted successfully.

Aspect 17 is the method of any of aspects 12-16, further includes that a MAC layer of the network entity provides the indication of the negative HARQ feedback.

Aspect 18 is an apparatus for wireless communication at a network entity including at least one processor coupled to a memory and at least one transceiver, the at least one processor configured to implement any of aspects 12-17.

Aspect 19 is an apparatus for wireless communication at a network entity including means for implementing any of aspects 12-17.

Aspect 20 is a computer-readable medium (e.g., non-transitory) storing computer executable code, where the code when executed by a processor causes the processor to implement any of aspects 12-17.

Aspect 21 is a method of wireless communication at a user equipment (UE), comprising: receiving from a network entity, an indication that a hybrid automatic repeat request (HARQ) process has failed or terminated at a medium access control (MAC) layer; and initiating, at a radio link control (RLC) layer, a retransmission of RLC protocol data units (PDUs) in response to receipt of the indication that the HARQ process has failed for the MAC layer.

In aspect 22, the method of aspect 21 further includes informing, from the MAC layer, the RLC layer of reception of the indication that the HARQ process has failed or terminated, wherein the RLC layer initiates the retransmission of the RLC PDUs based on information from the MAC layer that the HARQ process has failed or terminated.

In aspect 23, the method of aspect 21 or aspect 22 further includes that the indication that the HARQ process has failed or terminated is received in at least one of downlink control information (DCI) or medium access control-control element (MAC-CE).

In aspect 24, the method of any of aspects 21-23 further includes that the indication includes an identifier (ID) of the HARQ process that has terminated.

In aspect 25, the method of any of aspects 21-24 further includes transmitting an original set of RLC PDUs within a first MAC PDU, wherein the indication indicates that the HARQ process has failed or terminated for the original set of RLC PDUs.

In aspect 26, the method of any of aspects 21-25 further includes monitoring for a scheduling downlink control information (DCI) that includes a new data indicator (NDI).

In aspect 27, the method of aspect 26 further includes that reception of the scheduling DCI that includes a toggled NDI bit indicates that an initial transmission or the retransmission of the RLC PDUs was successfully received, and wherein the method further includes: discarding the RLC PDUs included within a second MAC PDU based on the reception of the scheduling DCI that includes the NDI bit toggled.

Aspect 28 is an apparatus for wireless communication at a UE including at least one processor coupled to a memory and, the at least one processor configured to implement any of aspects 21-27.

Aspect 29 is an apparatus for wireless communication at a UE including at least one processor coupled to a memory and at least one transceiver, the at least one processor configured to implement any of aspects 21-27.

Aspect 30 is an apparatus for wireless communication at a UE including means for implementing any of aspects 21-27.

Aspect 31 is a computer-readable medium (e.g., non-transitory) storing computer executable code, where the code when executed by a processor causes the processor to implement any of aspects 21-27.

Aspect 32 is a method of wireless communication at a network entity including: receiving, from a user equipment (UE), one or more transmissions that include radio link control (RLC) protocol data units (PDUs); transmitting, to the UE, an indication that a hybrid automatic repeat request (HARQ) process for the one or more transmissions has failed or terminated for a medium access control (MAC) layer; and receiving a retransmission of at least one of the RLC PDUs initiated from a radio link control (RLC) layer in response to the indication that the HARQ process has failed or terminated for the MAC layer.

In aspect 33, the method of aspect 32 further includes that the indication that the HARQ process has failed or terminated is included at least one of downlink control information (DCI) or medium access control-control element (MAC-CE).

In aspect 34, the method of aspect 32 or 33 further includes that the indication includes an identifier (ID) of the HARQ process that has terminated for the MAC layer.

In aspect 35, the method of any of aspects 32-34 further includes transmitting a scheduling downlink control information (DCI) that includes a toggled new data indicator (NDI) bit that indicates that an additional HARQ process for the RLC PDUs is successful.

In aspect 36, the method of any of aspects 32-35 further includes that the MAC layer of the network entity provides the indication of the negative HARQ feedback.

Aspect 37 is an apparatus for wireless communication at a UE including at least one processor coupled to a memory and, the at least one processor configured to implement any of aspects 32-36.

Aspect 38 is an apparatus for wireless communication at a UE including at least one processor coupled to a memory and at least one transceiver, the at least one processor configured to implement any of aspects 32-36.

Aspect 39 is an apparatus for wireless communication at a UE including means for implementing any of aspects 32-36.

Aspect 40 is a computer-readable medium (e.g., non-transitory) storing computer executable code, where the code when executed by a processor causes the processor to implement any of aspects 32-36.

What is claimed is:

1. An apparatus for wireless communication at a user equipment (UE), comprising:
at least one memory; and
at least one processor coupled to the at least one memory and, based at least in part on information stored in the at least one memory, the at least one processor is configured to:
receive, from a network entity, an indication that a hybrid automatic repeat request (HARQ) process has failed or terminated for a medium access control (MAC) layer; and
initiate, at a radio link control (RLC) layer, a retransmission of RLC protocol data units (PDUs) in response to receipt of the indication that the HARQ process has failed or terminated for the MAC layer.

2. The apparatus of claim 1, wherein the at least one processor is configured to:
inform, from the MAC layer, the RLC layer of reception of the indication that the HARQ process has failed or terminated, wherein the RLC layer initiates the retransmission of the RLC PDUs based on information from the MAC layer that the HARQ process has failed or terminated.

3. The apparatus of claim 1, further comprising a transceiver coupled to the at least one processor, wherein the indication that the HARQ process has failed or terminated for the MAC layer is included in at least one of downlink control information (DCI) or medium access control (MAC) control element (CE) (MAC-CE).

4. The apparatus of claim 1, wherein the indication includes an identifier (ID) of the HARQ process that has terminated.

5. The apparatus of claim 1, wherein the at least one processor is further configured to:
transmit an original set of RLC PDUs within a MAC PDU, wherein the indication indicates that the HARQ process has failed or terminated for the original set of RLC PDUs.

6. The apparatus of claim 1, wherein reception of a scheduling downlink control information (DCI) that includes a toggled new data indicator (NDI) bit indicates that an initial transmission or the retransmission of the RLC PDUs was successfully received, and wherein the at least one processor is further configured to:
discard the RLC PDUs included within a MAC PDU based on the reception of the DCI that includes the toggled NDI bit.

7. The apparatus of claim 1, wherein the at least one processor is configured to:
monitor for a scheduling downlink control information (DCI) that includes a new data indicator (NDI).

8. A method of wireless communication at a user equipment (UE), comprising:
receiving, from a network entity, an indication that a hybrid automatic repeat request (HARQ) process has failed or terminated at a medium access control (MAC) layer; and
initiating, at a radio link control (RLC) layer, a retransmission of RLC protocol data units (PDUs) in response to receipt of the indication that the HARQ process has failed for the MAC layer.

9. The method of claim 8, further comprising:
informing, from the MAC layer, the RLC layer of reception of the indication that the HARQ process has failed or terminated, wherein the RLC layer initiates the retransmission of the RLC PDUs based on information from the MAC layer that the HARQ process has failed or terminated.

10. The method of claim 8, wherein the indication that the HARQ process has failed or terminated is received in at least one of downlink control information (DCI) or medium access control-control element (MAC-CE).

11. The method of claim 8, wherein the indication includes an identifier (ID) of the HARQ process that has terminated.

12. The method of claim 8, further comprising:
transmitting an original set of RLC PDUs within a first MAC PDU, wherein the indication indicates that the HARQ process has failed or terminated for the original set of RLC PDUs.

13. The method of claim 12, further comprising:
monitoring for a scheduling downlink control information (DCI) that includes a new data indicator (NDI).

14. The method of claim 13, wherein reception of the scheduling DCI that includes a toggled NDI bit indicates that an initial transmission or the retransmission of the RLC PDUs was successfully received, and wherein the method further includes:
discarding the RLC PDUs included within a second MAC PDU based on the reception of the scheduling DCI that includes the NDI bit toggled.

15. An apparatus for wireless communication at a network entity, comprising:
at least one memory; and
at least one processor coupled to the at least one memory and, based at least in part on information stored in the at least one memory, the at least one processor is configured to:
receive, from a user equipment (UE), one or more transmissions that include radio link control (RLC) protocol data units (PDUs);
transmit, to the UE, an indication that a hybrid automatic repeat request (HARQ) process for the one or more transmissions has failed or terminated for a medium access control (MAC) layer; and
receive a retransmission of at least one of the RLC PDUs initiated from a radio link control (RLC) layer in response to the indication that the HARQ process has failed or terminated for the MAC layer.

16. The apparatus of claim 15, wherein the indication that the HARQ process has failed or terminated is included at least one of downlink control information (DCI) or medium access control-control element (MAC-CE).

17. The apparatus of claim 15, wherein the indication includes an identifier (ID) of the HARQ process that has terminated for the MAC layer.

18. The apparatus of claim 15, wherein the at least one processor is configured to:
transmit a scheduling downlink control information (DCI) that includes a toggled new data indicator (NDI) bit that indicates that an additional HARQ process for the RLC PDUs is successful.

19. The apparatus of claim 15, wherein the MAC layer of the network entity provides the indication that the HARQ process has failed or terminated.

20. The apparatus of claim 15, further comprising a transceiver coupled to the at least one processor.
